(19) United States
(12) Patent Application Publication
(10) Pub. No.: US 2024/0397868 A1
(43) Pub. Date: Dec. 5, 2024

(54) MODULAR OUTDOOR POWER EQUIPMENT

(71) Applicant: Milwaukee Electric Tool Corporation, Brookfield, WI (US)

(72) Inventors: Benjamin A. Smith, Milwaukee, WI (US); Keith A. Grider, Chicago, IL (US); Michael J. Caelwaerts, Menomonee Falls, WI (US); Austin F. de Veer, Milwaukee, WI (US); Maggie A. McLeod, Milwaukee, WI (US); Devlin N. Thyne, Milwaukee, WI (US); Kyle J. Reeder, Waukesha, WI (US); Joseph S. Wilinski, JR., Wauwatosa, WI (US); Michael Steven Van Dyke, Wauwatosa, WI (US)

(21) Appl. No.: 18/680,685

(22) Filed: May 31, 2024

Related U.S. Application Data
(60) Provisional application No. 63/505,893, filed on Jun. 2, 2023.

(51) Int. Cl. A01D 42/00

(52) U.S. Cl. CPC A01D 42/00

(57) ABSTRACT

A modular equipment assembly may include a base unit and a secondary front unit. The base unit may include a base frame, a motor, a tool interface, one or more wheels, and a handle. The motor may be mounted on the base frame. The tool interface may be disposed within the base frame in mechanical communication with the motor to removably attach a first tool head to the base frame. The one or more wheels may be mounted to the base frame apart from the movable tool to support the base unit. The handle may be mounted to and extend rearwardly from the base frame. The secondary front unit may be removably attached to the base unit, the secondary front unit may include a secondary front frame selectively disposed in front of the base frame forward from the tool interface to move with the base unit.

### PRIORITY STATEMENT

The present application claims the benefit of priority to U.S. Provisional Patent Application Ser. No. 63/505,893, filed on Jun. 2, 2023, the disclosure of which is incorporated by reference herein in its entirety.

### FIELD OF THE DISCLOSURE

The present disclosure relates generally to modular outdoor power equipment.

### BACKGROUND OF THE DISCLOSURE

In the field of power tools and equipment, a great number and variety of different tools exist. Many serve discrete and separate purposes. In most cases, these purposes do not overlap. For instance, different tools exist as edgers, aerators, sprayers, blowers, seeders, and dethatcher. Although often effective for their corresponding specific purposes, each of these tools can be expensive, bulky, or otherwise burdensome for most consumers to own. If used at all, many consumers have to lease or rent these tools. Unfortunately, options for renting may be limited, unreliable, or expensive in the aggregate. Additionally or alternatively, in certain segments of the outdoor power equipment, improved modularity is desired.

Accordingly, improvements which address the above-described issues are desired in the art and would be advantageous.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a modular equipment assembly is provided. The modular equipment assembly may include a base unit and a secondary front unit. The base unit may include a base frame, a motor, a tool interface, one or more wheels, and a handle. The base frame may extend along a transverse direction between a rear end and a front end. The motor may be mounted on the base frame. The tool interface may be disposed within the base frame in mechanical communication with the motor to removably attach a first tool head to the base frame. The one or more wheels may be mounted to the base frame apart from the movable tool to support the base unit. The handle may be mounted to and extend rearwardly from the base frame. The secondary front unit may be removably attached to the base unit, the secondary front unit may include a secondary front frame selectively disposed in front of the base frame forward from the tool interface to move with the base unit.

In another exemplary aspect of the present disclosure, a modular equipment assembly is provided. The modular equipment assembly may include a base unit and a secondary front unit. The base unit may include a base frame, a motor, a tool interface, a first tool head, one or more wheels, a handle, and a front support bar. The base frame may extend along a transverse direction between a rear end and a front end. The base frame may define a front opening at the front end. The motor may be mounted on the base frame. The tool interface may be disposed within the base frame rearward from the front opening in mechanical communication with the motor. The first tool head may be selectively attached the base frame in mechanical communication with the tool interface. The first tool head may include a rotatable blade or drum selectively driven by the motor through the tool interface. The one or more wheels may be mounted to the base frame apart from the movable tool to support the base unit. The handle may be mounted to and extend rearwardly from the base frame. The front support bar may be disposed on the front end. The secondary front unit may be removably attached to the base unit. The secondary front unit may include a secondary front frame and a front support hook. The secondary front frame may be selectively disposed in front of the base frame forward from the tool interface to move with the base unit. The front support hook may extend rearwardly in selective engagement with the front support bar.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a portion of a modular equipment assembly according to exemplary embodiments of the present disclosure.

FIG. 2 provides a side elevation view of a portion of a modular equipment assembly according to exemplary embodiments of the present disclosure.

FIG. 3 provides a schematic view of a modular equipment assembly according to exemplary embodiments of the present disclosure.

FIG. 4 provides a perspective view of a portion of a modular equipment assembly according to exemplary embodiments of the present disclosure.

FIG. 5 provides a perspective view of a modular equipment assembly according to exemplary embodiments of the present disclosure.

FIG. 6 provides a perspective view of a portion of a modular equipment assembly, including a separated base unit and secondary front unit, according to exemplary embodiments of the present disclosure.

FIG. 7 provides a perspective view of a portion of a modular equipment assembly, including an attached base unit and secondary front unit, according to exemplary embodiments of the present disclosure.

FIG. 8 provides a perspective view of a portion of a modular equipment assembly according to exemplary embodiments of the present disclosure.

FIG. 9 provides a perspective view of a portion of a modular equipment assembly according to exemplary embodiments of the present disclosure, wherein a tool head is removed from a base unit for clarity.

FIG. 10 provides a perspective view of a portion of a modular equipment assembly, including a separated base unit and secondary front unit, according to exemplary embodiments of the present disclosure.

FIG. 11 provides a perspective view of a portion of a modular equipment assembly, including an attached base unit and secondary front unit, according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Exemplary aspects of the present disclosure may include one or more features to advantageously facilitate or provide a system in which a single base unit can have one or more additional elements (e.g., tool head or secondary unit) selectively attached, removed, and reattached for performing tool or lawn-care functions. Optionally, multiple different secondary units can be provided and swapped on the base unit. The capabilities or functionality of the assembly may be able to change based on which tool head or secondary unit(s) is/are attached to the base unit at a given moment. For instance, the assembly may notably be able to act as an edger, blower, dethatcher, mower (e.g., reel mower), motorized broom, aerator, seeder (e.g., slitter or slit seeder), spreader (e.g., particulate fertilizer or pesticide spreader), or sprayer (e.g., particulate fertilizer or pesticide spreader) depending on which tool head or secondary unit is attached to the base unit.

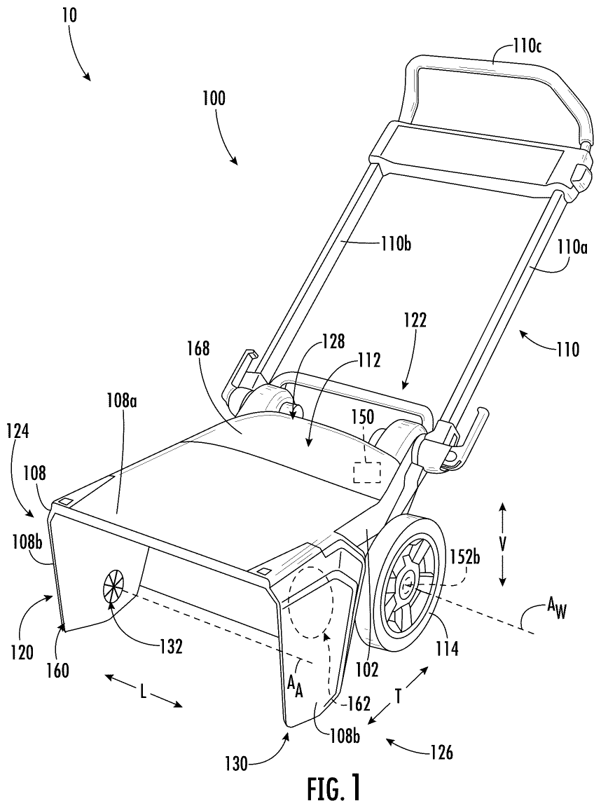

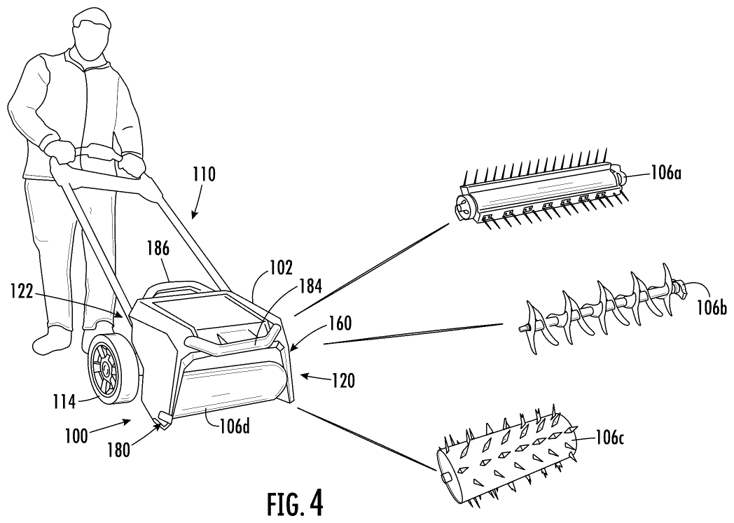

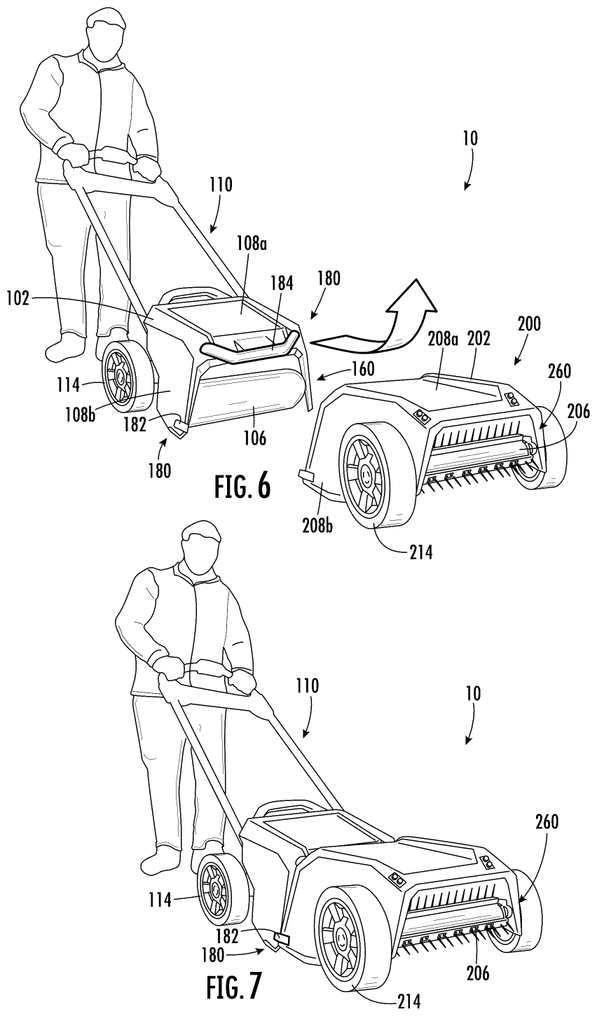

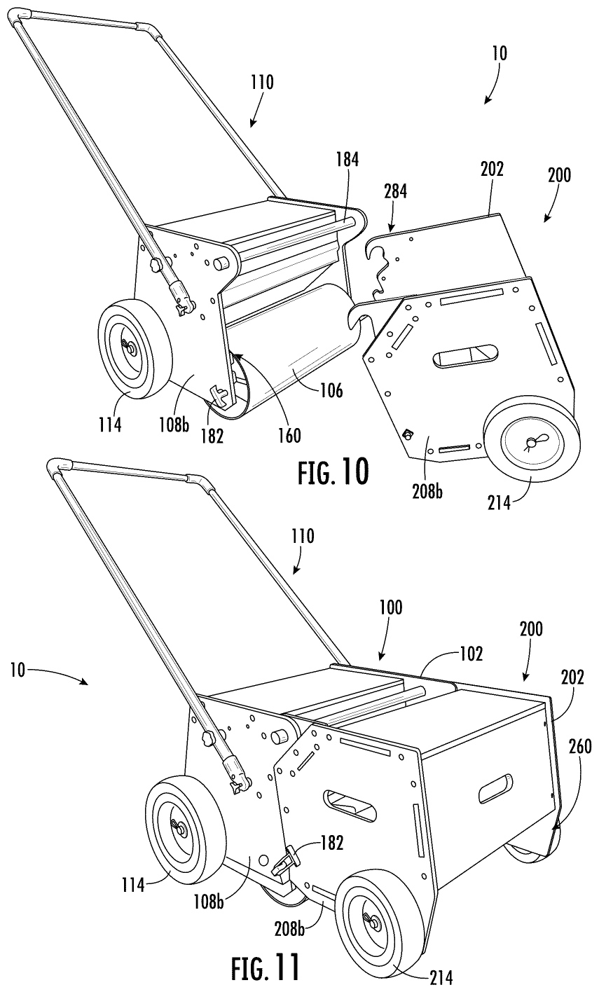

Referring now to the drawings, FIGS. 1 through 11 illustrate a modular equipment assembly (MEA) 10 in accordance with various exemplary embodiments of the present disclosure. As will be described in greater detail below, MEA 10 generally includes a base unit 100 and one or more secondary units 200, 300 that can be removably attached to the base unit 100.

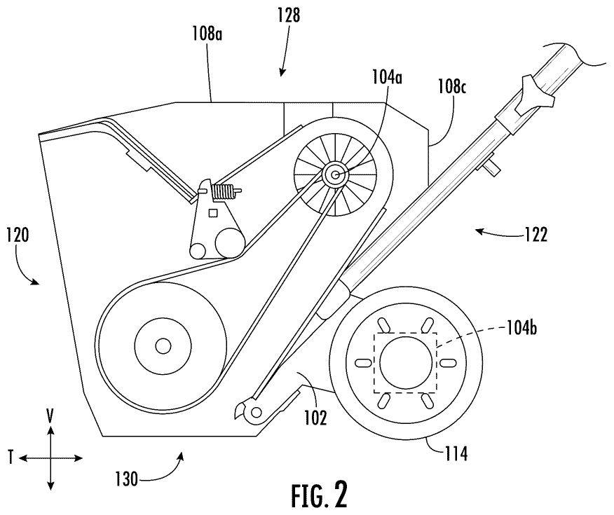

Turning especially to FIGS. 1 and 2, an exemplary base unit 100 is illustrated. Generally, base unit 100 defines a mutually orthogonal vertical direction V, lateral direction L, and transverse direction T. The base unit 100 includes a base frame 102, one or more motors 104 (e.g., element motor 104a or wheel motor 104b) and a tool interface 132 provided to receive one or more tool heads 106 removably coupled (e.g., rotatably mounted) to the base frame 102 (e.g., disposed in tool housing 108) to rotate about a defined tool axis AA.

As shown, base frame 102 extends along the transverse direction T between a front end 120 and a rear end 122, along the lateral direction between a first side 124 and a second side 126, and along the vertical direction V between a top end 128 and a bottom end 130.

Base unit 100 may further include a handle assembly 110 extending (e.g., rearwardly) from the base frame 102 (e.g., proximal to the top end 128). As illustrated, the handle assembly 110 can extend from the rear end 122 of the base frame 102 in a generally vertical direction V (e.g., at a non-parallel, non-orthogonal angle relative to the vertical direction V. A battery compartment 112 having a cover 168 can be coupled to the base frame 102 to receive one or more batteries or battery packs which can provide power to the one or more motors 104a, 104b (e.g., one more electric motors). In other embodiments, one or more motors 104a, 104b can include an engine powered by fuel. In such embodiments, a fuel storage tank (not illustrated) may be provided to store fuel for powering the engine.

The base unit 100 is supported by one or more walking elements (e.g., wheels 114). Generally, one or more wheels 114 define a wheel axis Aw (e.g., parallel to the lateral direction L) about which the wheels 114 rotate. In optional embodiments, the wheels 114 are provided as a pair of driven wheels that can be driven or rotated by a discrete wheel motor 104b (e.g., separate from element motor 104a). As illustrated, the wheel motor 104b may be supported on the base frame 102 apart from the element motor 104a. Although the driven wheels 114 may be motivated or rotated by wheel motor 104b, an operator or user may selectively push the base unit 100 (e.g., manually).

In some embodiments, a controller 150 may be provided in operative communication with one or more components of base unit 100 (e.g., motors 104a, 104b, etc.). The controller 150 may include a memory and one or more microprocessors, CPUs or the like, such as general or special purpose microprocessors operable to execute programming instructions or micro-control code associated with operation of base unit 100. The memory may represent random access memory such as DRAM, or read only memory such as ROM or FLASH. In some embodiments, the processor executes non-transitory programming instructions stored in memory. For certain embodiments, the instructions include a software package configured to operate base unit 100 or execute an operation routine. The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 150 may be positioned in a variety of locations throughout base unit 100. Input/output (“I/O”) signals may be routed between controller 150 and various operational components of base unit 100. One or more components of base unit 100 may be in operative communication (e.g., electric communication) with controller 150 via one or more conductive signal lines or shared communication busses.

In certain embodiments, handle assembly 110 include a top handle 110c (e.g., as an unbroken unitary piece or having left and right portions to receive a user's left and right hands, respectively). One or more inputs for controlling base unit 100 may be provided on or proximal to top handle 110c. Although top handle 110c is shown as a single-piece construction handle having left and right portions to receive a user's left and right hands, respectively. In other instances, the handle assembly 110 can include a multi-piece construction (e.g., having multiple discrete handles to receive a user's hands). The top handle 110c can be coupled to one or more additional portions, which extend from the base frame 102 to the first and second handles 110a and 110b (e.g., to support the top handle 110c or permit selective height adjustments or storage configurations of the handle assembly 110).

The tool housing 108 generally houses the tool head 106. As shown, tool housing 108 may include multiple walls, which house or at least partially enclose tool head 106. For instance, tool housing 108 may include a top wall 108a vertically bounding or disposed above tool head 106 (e.g., such that the tool head 106 is housed below the top wall 108a), a pair of side walls 108b laterally bounding tool head 106, or a rear wall 108c transversely bounding or disposed rearward from tool head 106. Generally, tool housing 108 may define one or more openings to or from the tooling housing 108. For instance, tool housing 108 may define an inlet opening 160 (e.g., at the front end 120) to permit fluids or materials (e.g., air, grass, clippings, dirt, snow, etc.) to the rotatable tool head 106. The inlet opening 160 may be defined in front of the rotatable tool head 106, such as by a pair of side walls 108b and top wall 108a. Separately from or in addition to inlet opening 160, tool housing 108 may define an outlet opening 162 to permit fluids or materials (e.g., air, grass, clippings, dirt, snow, etc.) to flow from rotatable tool head 106 (e.g., as motivated by the same) and out of tool housing 108 through outlet opening 162. In some embodiments, outlet opening 162 is defined through a side wall 108b.

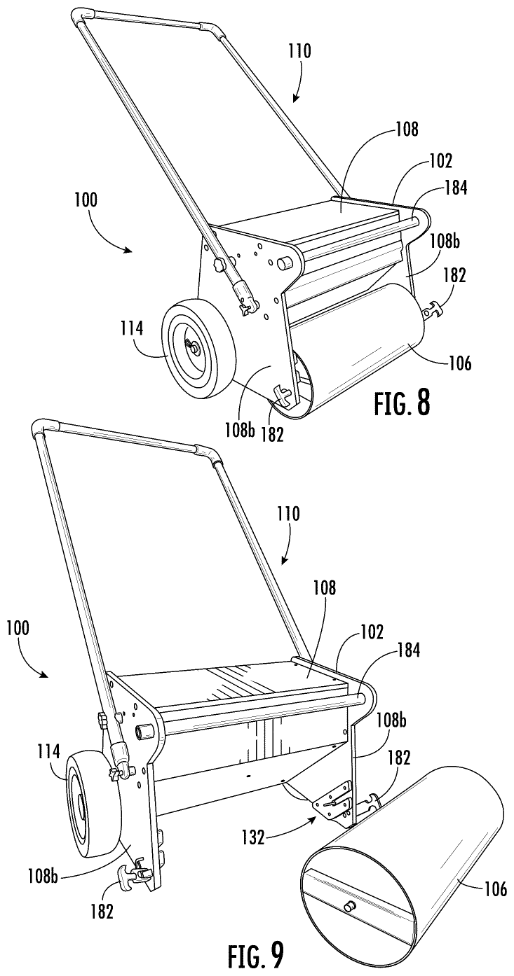

As noted, a tool interface 132 may be disposed within the base frame 102 in mechanical communication with the motor (e.g., directly or indirectly, such as via one or more pulleys, belts, or gears). For instance, tool interface 132 may be disposed rearwardly from front opening within tool housing 108. As illustrated, for instance in FIG. 9, tool interface 132 may define one or more channels or slots to receive or support a tool head 106. A toothed or geared coupling may be provided to mechanically couple or join the tool head 106 (e.g., at a central support shaft of the tool head 106) to the tool interface 132, such that rotation generated at the tool motor 104a may be transferred to the tool head 106 through the tool interface 132, as would be understood.

Referring generally to FIGS. 1 through 11, when assembled, tool head 106 may be mounted to base frame 102 and disposed below the top end 128 in mechanical communication with the tool interface 132. During use, tool head 106 may thus be able to rotate within tool housing 108 (e.g., about tool axis AA). Optionally, rotatable tool head 106 may be mounted to base frame 102 below outlet opening 162 (e.g., relative to the vertical direction V) to motivate material therethrough.

Generally, tool head 106 may include any suitable rotatable tool form, shape, or interface. For instance, tool head 106 may include a rotatable blade or drum to be rotated by the tool motor 104a (e.g., through the tool interface 132). As an example, a tool head 106 may include or be provided as a dethatcher head 106a, including a support drum with a plurality of needle tines extending therefrom (e.g., arranged in one or more axial or helical rows). As an additional or alternative example, a tool head 106 may include or be provided as a scarifier head 106b, including a support shaft with a plurality of axially spaced and radially extending scarifier (e.g., dual, radially opposite) blades. As another additional or alternative example, a tool head 106 may include or be provided as an aerator head 106c, including a ground-engagement drum with a plurality of axially and circumferentially spaced spikes extending therefrom. As yet another, additional or alternative example, a tool head 106 may include or be provided as a drum head 106d, including a solid cylindrical compacting drum having a flat or smooth circumferential contact face (e.g., free of any tines, blades, or spikes). As still another additional or alternative example, a tool head 106 may include or be provided as a reel-mower head 106c, including a plurality of helical reel-mower blades, as are understood. As still another additional or alternative example, a tool head 106 may include or be provided as a cylindrical broom head 106f, including a plurality of brush bristles extending from a support shaft, as would be understood. As still another additional or alternative example, a tool head 106 may include or be provided as a slitter or slit seeder head 106g, including a plurality of seeder blades (e.g., circular blades) extending about a central shaft, as would be understood.

As noted above, a tool head 106 may be removably attached to base frame 102. Optionally, assembly 10 may include multiple discrete (e.g., first, second, third, etc.) tool heads that may be selectively swapped, exchanged, or otherwise removed from base frame 102. Specifically, a plurality of tool heads 106 may be interchangeably mounted against the tool interface 132. Thus, although some embodiments may permit only a single tool head 106 to be attached at a given moment, another tool head 106 may be provided to be stored (e.g., apart from base frame 102) and swapped on the base frame 102 as desired. As an example, a first tool head 106 may be selectively removed or separated from base frame 102 (e.g., such that the first tool head 106 is no longer mounted against the tool interface 132) and a second tool head 106 may be attached to the base frame 102 (e.g., thereby mounting the second tool head against the tool interface 132)—and vice versa—as desired for a given use instance. In turn, a user may be able to advantageously select and attach a tool head 106 in accordance with a desired functionality, thereby permitting base unit 100 to perform a plurality of different roles based on which tool head 106 is attached to base frame 102 at any given moment.

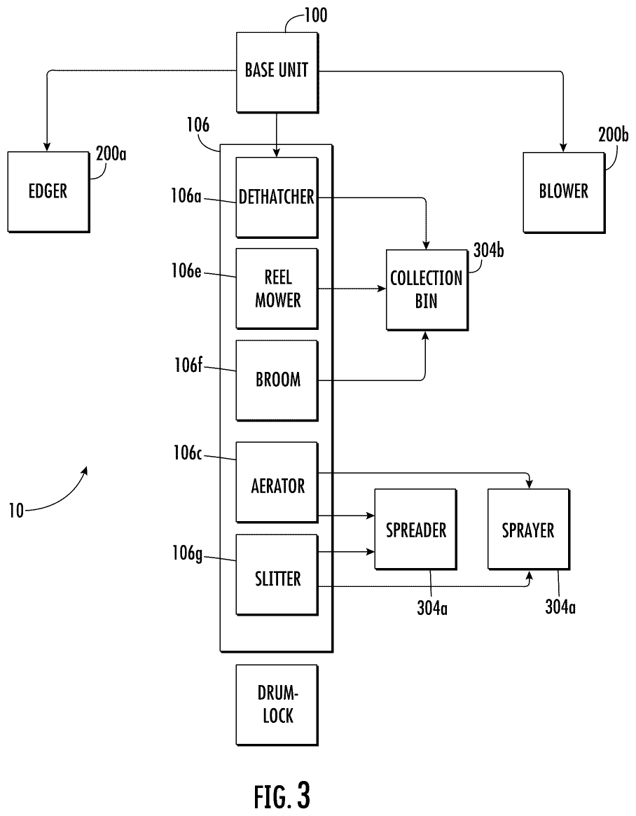

Turning especially to FIGS. 3, 5, 6, 10, and 11, one or more secondary front units 200 may be provided (e.g., to removably attach to and work in tandem with base unit 100). Generally, a secondary front unit 200 includes a secondary front frame 202 that can be selectively disposed in front of the base frame 102 forward from the tool interface 132 to move with the base unit 100. As shown, the secondary front frame 202 may include one or more secondary walls (e.g., at a top, front, or side portion of the secondary front frame 202) that can, at least partially, cover or enclose the front inlet opening 160 of the base unit 100 (e.g., as will be described in detail below).

In certain embodiments, the secondary front frame 202, or secondary front unit 200 generally, is supported by one or more walking elements (e.g., wheels 214). Generally, such wheels 214 may define a wheel axis (e.g., parallel to the lateral direction L or wheel axis Aw) about which the wheels 214 rotate.

In some embodiments, secondary front frame 202 houses a movable secondary tool 206. Specifically, a secondary housing of secondary front frame 202 may house or at least partially enclose secondary tool 206 (i.e., secondary tool head). For instance, secondary front frame 202 may include a top secondary wall 308a vertically bounding or disposed above secondary tool 206 (e.g., such that the secondary tool 206 is housed below the top secondary wall 208a), a pair of side secondary walls 208b laterally bounding secondary tool 206, or a front secondary wall transversely bounding or disposed forward from secondary tool 206. Generally, secondary front frame 202 may define one or more openings to or from the tooling housing 108. For instance, secondary front frame 202 may define a secondary inlet opening 260 (e.g., at a front or bottom portion of secondary front frame 202) to permit fluids or materials (e.g., air, grass, clippings, dirt, snow, etc.) to the rotatable secondary tool 206.

Secondary tool 206 may be provided a passive or active rotatable member. Specifically, when assembled, the secondary tool 206 may be rotatably supported on the secondary front frame 202. The secondary tool 206 may include or be provided as a rotatable blade or drum and, optionally, further include the secondary tool head 206 comprising one or more spikes or blades. For instance, as would be understood in light of the present disclosure, the secondary tool head 206 may include a dethatcher head, a scarifier head, an acrator head, a drum head, a reel-mower head, a cylindrical broom head, as a slitter or slit seeder head, a edger blade head (e.g., such that secondary front unit is provided as an edger unit 200a), or a blower impeller or fan head (e.g., such that secondary front unit is provided as a blower unit 200b). In optional embodiments (e.g., passive embodiments) can be driven to rotate based on or in response traveling (e.g., forward or rearward) movement of secondary front unit 200. As an example, the secondary tool 206 may be rotationally fixed relative to the wheels 214 such that rotational movement of the wheels 214 is transferred to secondary tool 206 (e.g., to rotate secondary tool 206 in tandem with rotation of the wheels 214). Thus, the secondary tool 206 may be in mechanical communication with the wheels 214. As an additional or alternative example, the secondary tool 206 may be disconnected from the tool interface 132 or wheels 214. Rotation of the secondary tool 206 may be driven, for instance, by frictional engagement or contact between the rotational tool 206 and a ground surface. In alternative embodiments (e.g., active embodiments), the secondary tool 206 may be in mechanical communication with the tool interface 132 of the base unit 100 (e.g., via one or more suitable gearing or drivetrain couplings, as would be understood). Thus, the secondary tool 206 may be selectively driven to rotate as motivated by the tool motor 104a. In other words, rotation generated at the tool motor 104a may be transferred to the secondary tool 206 through the tool interface 132, as would be understood.

As noted above, a secondary front unit 200 may be removably attached to base unit 100. To that end, one or more connector assemblies 180 may be provided to support or facilitate selective engagement between base unit 100 and secondary front unit 200. In some embodiments, a connector assembly 180 is included or provided as one or more frame locks 182. For instance, a pair of frame locks 182 may be disposed on the first and second sides 124, 126 of the base unit 100 in selective locked engagement with the secondary front frame 202. Such frame locks 182 may each include a movable latch member (e.g., a clip, toggle, prong, hooked finger, etc.) that is selectively aligned in attached engagement with a complementary catch member (e.g., a ridge, recess, notch, post, etc.) disposed on the secondary front unit 200.

In additional or alternative embodiments, a front support bar 184 and one or more complementary front support hooks 284 are provided between the base unit 100 and the secondary front unit 200. For instance, a front support bar 184 may be disposed on the front end 120 of the base frame 102. As shown, at least a portion of front support bar 184 may extend laterally or otherwise orthogonally relative to the vertical direction V. The front support hook(s) 284 by contrast may extend rearwardly from the secondary front unit 200. The notches of a front support hook 284 may be opened or directed downward. In turn, the base unit 100 or secondary front unit 200 may be pivoted or tilted forward such that the front support bar 184 is disposed below the front support hook(s) 284 to attach the units (e.g., by further lifting the front support bar 184 onto the front support hook(s) 284) or detach the units (e.g., by further translating one of the units along the ground away from the other unit). Separate from or in addition to the connector assemblies 180, secondary front frame 202 may be complementary to base frame 102 such that one or more secondary walls align with (e.g., to fit against) one or more corresponding walls of the base unit 100.

As noted above, a secondary front unit 200 may be removably attached to base unit 100. Optionally, assembly 10 may include multiple discrete (e.g., first, second, third, etc.) secondary front units 200 that may be selectively swapped, exchanged, or otherwise removed from base unit 100. Specifically, a plurality of secondary front units 200 may be interchangeably mounted against the front of base unit 100. Thus, although some embodiments may permit only a secondary front unit 200 to be attached at a given moment, another secondary front unit 200 may be provided to be stored (e.g., apart from base unit 100) and swapped on the base unit 100 as desired. As an example, a first secondary front unit 200 may be selectively removed or separated from base unit 100 (e.g., such that the first secondary front unit 200 is no longer mounted against the base unit 100) and a second secondary front unit 200 may be attached to the base unit 100 (e.g., thereby mounting the second secondary front unit 200 against the base unit 100)—and vice versa—as desired for a given use instance. In turn, a user may be able to advantageously select and attach a secondary front unit 200 in accordance with a desired functionality (e.g., complementing the tool head 106 or configuration of the base unit 100), thereby permitting assembly 10 to perform a plurality of different roles based on which secondary front unit 200 is attached to base unit 100 at any given moment.

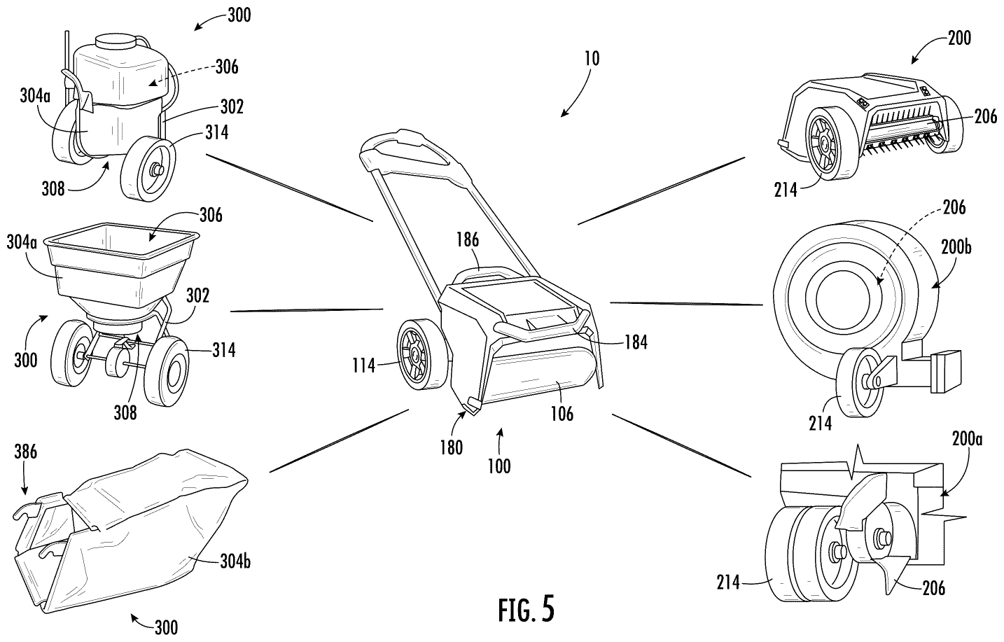

Turning especially to FIGS. 3 and 5, one or more secondary rear units 300 may be provided (e.g., to removably attach to and work in tandem with base unit 100). Generally, a secondary rear unit 300 includes a secondary rear frame 302 that can be selectively disposed in front of the base frame 102 rearward from the tool interface 132 to move with the rear unit. In optional embodiments, the secondary rear frame 302, or secondary rear unit 300 generally, is supported by one or more walking elements (e.g., wheels 314). Generally, such wheels 314 may define a wheel axis (e.g., parallel to the lateral direction L or wheel axis Aw) about which the wheels 314 rotate.

In some embodiments, secondary rear frame 302 supports one or more container bodies 304. As an example, a container body 304 may be provided as or include a hopper 304a (e.g., sprayer or spreader hopper 304a) supported on the secondary rear frame 302. Generally, the hopper 304a may define a storage chamber 306 for a distributed material (e.g., liquid or particulate material, such as a fertilizer or pesticide). The storage chamber 306 may be selectively sealed or enclosed (e.g., via a movable lid) or, alternatively, provided as an open container (e.g., having an upper opening exposed to the ambient environment). Downstream from the storage chamber 306, a material outlet 308 may be provided on or defined by the hopper 304a to release the distributed material behind the base unit 100. Optionally, a sprayer nozzle or spreader disc may be provided on or downstream from the material outlet 308 to facilitate the spread of the distributed material, as would be understood.

In additional or alternative embodiments, a container body 304 may be provided as or include a collection bin 304b supported on the secondary rear frame 302. The collection may include one or more rigid panels or a fabric body (e.g., held on a rigid or semi-rigid scaffolding) that generally define or defines a bin cavity. In some such embodiments, the base unit 100 or base frame 102 defines a rear opening that is directed rearward. When assembled such that the secondary rear unit 300 is attached to the base unit 100, the rear opening may be directed toward the collection bin 304b. Thus, the bin cavity or container body 304 generally may be disposed downstream from the first tool head 106 to receive a particulate therefrom.

As noted above, a secondary rear unit 300 may be removably attached to base unit 100. To that end, one or more connector assemblies 180 may be provided to support or facilitate selective engagement between base unit 100 and secondary front unit 200. In some embodiments,

In additional or alternative embodiments, a rear support bar 186 and one or more complementary rear support hooks 386 are provided between the base unit 100 and the secondary rear unit 300. For instance, a rear support bar 186 may be disposed on the rear end 122 of the base frame 102. As shown, at least a portion of rear support bar 186 may extend laterally or otherwise orthogonally relative to the vertical direction V. The rear support hook(s) 386 by contrast may extend forwardly from the secondary rear unit 300. The notches of a rear support hook 386 may be opened or directed downward. In turn, the base unit 100 or secondary rear unit 300 may be pivoted or tilted rearward such that the rear support bar 186 is disposed below the rear support hook(s) 386 to attach the units (e.g., by further lifting the rear support bar 186 onto the rear support hook(s) 386 or detach the units (e.g., by further translating one of the units along the ground away from the other unit).

Further aspects of the invention are provided by one or more of the following embodiments:

A modular equipment assembly comprising: a base unit comprising a base frame extending along a transverse direction between a rear end and a front end, a motor mounted on the base frame, a tool interface disposed within the base frame in mechanical communication with the motor to removably attach a first tool head to the base frame, one or more wheels mounted to the base frame apart from the movable tool to support the base unit, and a handle mounted to and extending rearwardly from the base frame; and a secondary front unit removably attached to the base unit, the secondary front unit comprising a secondary front frame selectively disposed in front of the base frame forward from the tool interface to move with the base unit.

The modular equipment assembly of any one or more of the embodiments, further comprising a plurality of tool heads interchangeably mounted against the tool interface, the plurality of tool heads comprising the first tool head.

The modular equipment assembly of any one or more of the embodiments, wherein the base frame extends along a lateral direction between a first side and a second side, and wherein the base unit further comprises a pair of frame locks disposed on the first and second sides in selective locked engagement with the secondary front frame.

The modular equipment assembly of any one or more of the embodiments, wherein the base unit further comprises a support bar disposed on the front end, and wherein the secondary front unit further comprises a support hook extending rearwardly in selective engagement with the support bar.

The modular equipment assembly of any one or more of the embodiments, wherein the secondary front unit further comprises a secondary tool head rotatably supported on the secondary front frame, the secondary tool head comprising one or more spikes or blades.

The modular equipment assembly of any one or more of the embodiments, wherein the secondary tool head is in mechanical communication with the tool interface to be driven by the motor through the tool interface.

The modular equipment assembly of any one or more of the embodiments, wherein the secondary front unit further comprises one or more wheels mounted to the secondary front frame apart from the base unit to support the secondary front unit.

The modular equipment assembly of any one or more of the embodiments, further comprising a secondary rear unit removably attached to the base unit, the secondary rear unit comprising a secondary rear frame selectively disposed behind the base frame rearward from the tool interface to move with the base unit.

The modular equipment assembly of any one or more of the embodiments, wherein the secondary rear unit further comprises a hopper defining a storage chamber for a distributed material supported on the secondary rear frame and a material outlet downstream from the storage chamber to release the distributed material behind the base unit.

The modular equipment assembly of any one or more of the embodiments, wherein the secondary rear unit further comprises a collection bin supported on the secondary rear frame downstream from the first tool head to receive a particulate therefrom.

The modular equipment assembly of any one or more of the embodiments, wherein the base unit further comprises a support bar disposed on the rear end, and wherein the secondary rear unit further comprises a support hook extending forwardly in selective engagement with the support bar.

A modular equipment assembly comprising: a base unit comprising a base frame extending along a transverse direction between a rear end and a front end, the base frame defining a front opening at the front end, a motor mounted on the base frame, a tool interface disposed within the base frame rearward from the front opening in mechanical communication with the motor, a first tool head selectively attached the base frame in mechanical communication with the tool interface, the first tool head comprising a rotatable blade or drum selectively driven by the motor through the tool interface, one or more wheels mounted to the base frame apart from the movable tool to support the base unit, a handle mounted to and extending rearwardly from the base frame, and a support bar disposed on the front end; and a secondary front unit removably attached to the base unit, the secondary front unit comprising a secondary front frame selectively disposed in front of the base frame forward from the tool interface to move with the base unit, and a support hook extending rearwardly in selective engagement with the support bar.

The modular equipment assembly of any one or more of the embodiments, further comprising a plurality of tool heads interchangeably mounted against the tool interface, the plurality of tool heads comprising the first tool head.

The modular equipment assembly of any one or more of the embodiments, wherein the base frame extends along a lateral direction between a first side and a second side, and wherein the base unit further comprises a pair of frame locks disposed on the first and second sides in selective locked engagement with the secondary front frame.

The modular equipment assembly of any one or more of the embodiments, wherein the secondary front unit further comprises a secondary tool head rotatably supported on the secondary front frame, the secondary tool head comprising one or more spikes or blades.

The modular equipment assembly of any one or more of the embodiments, wherein the secondary front unit further comprises one or more wheels mounted to the secondary front frame apart from the base unit to support the secondary front unit.

The modular equipment assembly of any one or more of the embodiments, further comprising a secondary rear unit removably attached to the base unit, the secondary rear unit comprising a secondary rear frame selectively disposed behind the base frame rearward from the tool interface to move with the base unit.

The modular equipment assembly of any one or more of the embodiments, wherein the secondary rear unit further comprises a hopper defining a storage chamber for a distributed material supported on the secondary rear frame and a material outlet downstream from the storage chamber to release the distributed material behind the base unit.

The modular equipment assembly of any one or more of the embodiments, wherein the secondary rear unit further comprises a collection bin supported on the secondary rear frame downstream from the first tool head to receive a particulate therefrom.

The modular equipment assembly of any one or more of the embodiments, wherein the base unit further comprises a support bar disposed on the rear end, and wherein the secondary rear unit further comprises a support hook extending forwardly in selective engagement with the support bar.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A modular equipment assembly comprising:
a base unit comprising
a base frame extending along a transverse direction between a rear end and a front end,
a motor mounted on the base frame,
a tool interface disposed within the base frame in mechanical communication with the motor to removably attach a first tool head to the base frame,
one or more wheels mounted to the base frame apart from the tool interface to support the base unit, and
a handle mounted to and extending rearwardly from the base frame; and
a secondary front unit removably attached to the base unit, the secondary front unit comprising
a secondary front frame selectively disposed in front of the base frame forward from the tool interface to move with the base unit.

2. The modular equipment assembly of claim 1, further comprising a plurality of tool heads interchangeably mounted against the tool interface, the plurality of tool heads comprising the first tool head.

3. The modular equipment assembly of claim 1, wherein the base frame extends along a lateral direction between a first side and a second side, and wherein the base unit further comprises a pair of frame locks disposed on the first and second sides in selective locked engagement with the secondary front frame.

4. The modular equipment assembly of claim 1, wherein the base unit further comprises a support bar disposed on the front end, and wherein the secondary front unit further comprises a support hook extending rearwardly in selective engagement with the support bar.

5. The modular equipment assembly of claim 1, wherein the secondary front unit further comprises a secondary tool head rotatably supported on the secondary front frame, the secondary tool head comprising one or more spikes or blades.

6. The modular equipment assembly of claim 5, wherein the secondary tool head is in mechanical communication with the tool interface to be driven by the motor through the tool interface.

7. The modular equipment assembly of claim 1, wherein the secondary front unit further comprises one or more wheels mounted to the secondary front frame apart from the base unit to support the secondary front unit.

8. The modular equipment assembly of claim 1, further comprising a secondary rear unit removably attached to the base unit, the secondary rear unit comprising
a secondary rear frame selectively disposed behind the base frame rearward from the tool interface to move with the base unit.

9. The modular equipment assembly of claim 8, wherein the secondary rear unit further comprises
a hopper defining a storage chamber for a distributed material supported on the secondary rear frame and a material outlet downstream from the storage chamber to release the distributed material behind the base unit.

10. The modular equipment assembly of claim 8, wherein the secondary rear unit further comprises a collection bin supported on the secondary rear frame downstream from the first tool head to receive a particulate therefrom.

11. The modular equipment assembly of claim 10, wherein the base unit further comprises a support bar disposed on the rear end, and wherein the secondary rear unit further comprises a support hook extending forwardly in selective engagement with the support bar.

12. A modular equipment assembly comprising:
a base unit comprising
a base frame extending along a transverse direction between a rear end and a front end, the base frame defining a front opening at the front end,
a motor mounted on the base frame,
a tool interface disposed within the base frame rearward from the front opening in mechanical communication with the motor,
a first tool head selectively attached the base frame in mechanical communication with the tool interface, the first tool head comprising a rotatable blade or drum selectively driven by the motor through the tool interface,
one or more wheels mounted to the base frame apart from the tool interface to support the base unit,
a handle mounted to and extending rearwardly from the base frame, and
a support bar disposed on the front end; and
a secondary front unit removably attached to the base unit, the secondary front unit comprising
a secondary front frame selectively disposed in front of the base frame forward from the tool interface to move with the base unit, and
a support hook extending rearwardly in selective engagement with the support bar.

13. The modular equipment assembly of claim 12, further comprising a plurality of tool heads interchangeably mounted against the tool interface, the plurality of tool heads comprising the first tool head.

14. The modular equipment assembly of claim 12, wherein the base frame extends along a lateral direction between a first side and a second side, and wherein the base unit further comprises a pair of frame locks disposed on the first and second sides in selective locked engagement with the secondary front frame.

15. The modular equipment assembly of claim 12, wherein the secondary front unit further comprises a secondary tool head rotatably supported on the secondary front frame, the secondary tool head comprising one or more spikes or blades.

16. The modular equipment assembly of claim 12, wherein the secondary front unit further comprises one or more wheels mounted to the secondary front frame apart from the base unit to support the secondary front unit.

17. The modular equipment assembly of claim 12, further comprising a secondary rear unit removably attached to the base unit, the secondary rear unit comprising
a secondary rear frame selectively disposed behind the base frame rearward from the tool interface to move with the base unit.

18. The modular equipment assembly of claim 17, wherein the secondary rear unit further comprises
a hopper defining a storage chamber for a distributed material supported on the secondary rear frame and a material outlet downstream from the storage chamber to release the distributed material behind the base unit.

19. The modular equipment assembly of claim 17, wherein the secondary rear unit further comprises a collection bin supported on the secondary rear frame downstream from the first tool head to receive a particulate therefrom.

20. The modular equipment assembly of claim 17, wherein the base unit further comprises a support bar disposed on the rear end, and wherein the secondary rear unit further comprises a support hook extending forwardly in selective engagement with the support bar.
